(19) United States
(12) Patent Application Publication
(10) Pub. No.: US 2008/0133351 A1
(43) Pub. Date: Jun. 5, 2008

(54) METHOD AND APPARATUS FOR REWARD MESSAGING, DISCOUNTING AND REDEMPTION AT THE POINT OF INTERACTION

(76) Inventors: Brigette White, Cortland Manor, NY (US); Andrea Gilman, Chappaqua, NY (US); Burnett Hunter, Briarcliff Manor, NY (US); Sara Fiebiger, Ellisville, MO (US); Dennis J. Hill, St. Paul, MO (US); Bengt Horsma, Brookfield, CT (US)

Correspondence Address: BUCKLEY, MASCHOFF & TALWALKAR LLC, 50 LOCUST AVENUE, NEW CANAAN, CT, 06840, US

(21) Appl. No.: 11/923,306

(22) Filed: Oct. 24, 2007

Related U.S. Application Data
(60) Provisional application No. 60/862,740, filed on Oct. 24, 2006.

(51) Int. Cl. G06Q 20/00; G06Q 30/00

(52) U.S. Cl. 705/14

(57) ABSTRACT

Systems, methods, apparatus, means and computer program code are provided including receiving, from a point of interaction, an authorization request message identifying a requested purchase transaction, the authorization request message including data identifying a payment account identifier and a purchase amount; determining that the payment account identifier is eligible for a reward and selecting a reward message associated with the reward; and transmitting an authorization response message including the reward message to the point of interaction for display to an account holder.

### CROSS-REFERENCE TO RELATED APPLICATION

This application claims the benefit of and priority to provisional patent application Ser. No. 60/862,740, filed Oct. 24, 2006, the contents of which are hereby incorporated by reference herein in their entirety.

### BACKGROUND

Embodiments disclosed herein relate to payment systems. In particular, some embodiments relate to methods, apparatus, systems, means and computer program products for processing rewards at the point of interaction (e.g., such as at point of sale (“POS”) locations).

Payment card loyalty programs have been in wide spread use for some time. Most customers who hold payment cards participate in some form of loyalty program, including merchant-specific frequent buyer programs, airline mileage programs, or the like. In general, these programs are successful, as many customers who participate in loyalty programs indicate that their participation in the programs has an impact on their purchasing decisions.

Unfortunately, the ubiquity of these programs has led to dilution of their impact. With so many programs, and so little differentiation, customer's behaviors are not directly driven by the programs. As a result, many customers do not actively participate in many loyalty programs even after they have enrolled.

The reward delivery mechanism for most loyalty programs has primarily been the use of store coupons, statement inserts or other printed coupons that require a customer to redeem the coupon in a future purchase. Currently, it is estimated that the percentage of reward coupons that are redeemed by customers is less than 1% of the total coupons distributed. As card based reward programs and benefits become more widespread, financial institutions and other entities are searching for more cost effective ways to deliver value to their cardholders.

Further, many merchants simply do not have the expertise or ability to effectively use their customer data to develop and administer reward programs. It would be desirable to reduce the barriers to customers to make it easier for them to participate and receive awards. It would further be desirable to provide systems and methods that allow merchants and/or financial institutions to easily deploy and administer reward programs.

### BRIEF DESCRIPTION OF THE DRAWINGS

Features and advantages of some embodiments of the present invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a block diagram illustrating an authorization process according to some embodiments of the present invention.

FIG. 2 is a block diagram illustrating a further authorization process according to some embodiments of the present invention.

FIG. 3 is a flow diagram illustrating a rewards messaging authorization process according to some embodiments of the present invention.

FIG. 4 is a flow diagram illustrating a discounting authorization process according to some embodiments of the present invention.

FIG. 5 is a flow diagram illustrating a rewards point redemption authorization process according to some embodiments of the present invention.

FIG. 6 is a database diagram illustrating portions of a rewards datastore pursuant to some embodiments of the present invention.

FIG. 7 is a further database diagram illustrating portions of a rewards datastore pursuant to some embodiments of the present invention.

FIG. 8 is a further database diagram illustrating portions of a rewards datastore pursuant to some embodiments of the present invention.

FIG. 9 is a schematic view of a point of sale device according to some embodiments of the present invention.

FIG. 10 is a further schematic view of a point of sale device according to some embodiments of the present invention.

FIG. 11 is a further schematic view of a point of sale device according to some embodiments of the present invention.

### DETAILED DESCRIPTION

Applicants have recognized that there is a need for methods, systems, apparatus, means and computer program products for processing rewards at the point of sale. In some embodiments, methods, systems, apparatus, means and computer program products are provided to deliver real time messaging, including, for example, rewards messaging, information regarding statement rebates, and complementary offers such as treats or services, and points balances. In some embodiments, methods, systems, apparatus, means and computer program products are provided to deliver real time discounts at the point of sale. In some embodiments, methods, systems, apparatus, means and computer program products are provided to allow reward points redemption at the point of sale.

In general, and for the purpose of introducing concepts of embodiments of the present invention, one or more rewards programs funded in whole or in part by one or more entities (e.g., one or more merchants, issuers, payment systems, payment processors, or product manufacturers) are implemented via a payment transaction authorization network such as the BankNet® system administered by MasterCard International, Inc., the assignee hereof. A rewards system computer and/or a reward data source is associated with the payment transaction authorization network. The rewards system computer and/or the reward data source store information that defines the rewards programs, including information indicating which purchase transactions qualify for rewards, merchant and acquirer information identifying qualifying transactions, the amounts of the rewards, and any reward messaging to be delivered to the point of interaction for communication to the customer. In some embodiments, the rewards system computer and/or the reward data source also store information associated with individual reward accounts, including, for example, the reward point balance associated with each account.

Payment transaction authorization requests are screened to identify payment transactions that qualify for rewards. Pursuant to some embodiments, any authorization requests associated with qualifying purchases are supplemented with appropriate reward messaging data for delivery to the point of interaction. Pursuant to some embodiments, details about the rewards are transmitted to a point of interaction for communication to the customer during the transaction (e.g., by printing on a receipt, by display on a terminal, etc.). In some embodiments, the rewards may be delivered to the customer in the customer's next payment card statement cycle. In some embodiments, the rewards are delivered to the customer in the current transaction as a reduction in the overall transaction amount. In some embodiments, messaging may be delivered informing the customer of a reward or a discount they can receive at a later visit to the merchant, or of the number or amount of additional transactions or purchases needed to qualify for a reward or discount. In some embodiments, the customer may be able to view their points balance and, if eligible, redeem points during the transaction, thereby reducing the purchase price of the transaction.

These systems and methods allow for rewards information to be communicated to customers during the qualifying transaction, providing the customer with immediate gratification and, in some embodiments, with immediate benefits of the reward. Processing and administrative economies are realized by using a previously existing payment processing network as the vehicle for identification, communication and delivery of rewards (including, for example, statement rebates, discounts, and points redemptions). In some embodiments, little or no modification of the payment processing network itself is required, since a separate rewards system computer is associated with or in communication with the payment processing network to generate the rebate transactions to be handled through existing mechanism of the payment processing network.

As used herein, features of embodiments will be described in conjunction with “payment cards”. A payment card may include (but is not limited to), for example, credit cards, debit cards, stored value cards, or other payment devices associated with payment accounts. In some embodiments, features may be used in conjunction with “loyalty cards” or devices used to identify a member's participation in a loyalty program. A payment card or loyalty card may be embodied in various forms, including, for example, as a magnetic stripe card, a radio frequency identification (“RFID”) card or other “contactless” card, smart card, or the like. Further, embodiments may also be used in conjunction with virtual cards (e.g., where no physical card is used for a transaction), or other payment devices (such as, for example, contactless key fobs, payment-enabled mobile devices or telephones, or the like). Further, although features will be described in an illustrative example with transactions conducted in the U.S., embodiments may be used in any region or cross-regions.

As used herein, the terms “POS” or “POS terminal” are used to refer to devices provided at a “point of interaction” with a customer to enable the customer to make a purchase or conduct a transaction. For example, a POS device may be a POS terminal located at a physical point of sale location (such as a brick and mortar merchant retail location), or a virtual POS device (such as a “shopping cart” used by an Internet retailer to facilitate a payment transaction over the Internet), or a virtual terminal used by a mail order or telephone retailer to facilitate transactions over the telephone or by mail. In general, as used herein, the term POS or POS terminal refers to any device or set of devices that are provided at a point of interaction with a customer during a purchase or sale transaction.

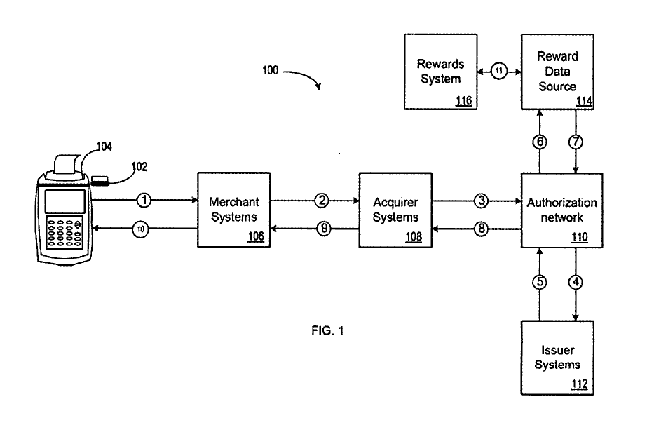

In some embodiments, methods, systems, apparatus, means and computer program products are provided to deliver real time rewards messaging and statement rebates. Pursuant to these embodiments, customers are made instantly (or substantially in real time during the course of a transaction) aware of special offers such as rebates that are realized subsequent to the date or time of purchase. These embodiments will generally be referred to herein as the “messaging” embodiments, and will be described herein in conjunction with FIGS. 1-3, 6 and 9 (although features of the rewards messaging embodiments may also be utilized in the embodiments described in conjunction with the other Figures). In general, the rewards messaging embodiments allow personalized and relevant reward messages to be communicated to a customer during a purchase transaction. The reward messages may include messaging about a reward that the customer has earned and will be reflected on an upcoming statement, about a reward that the customer can enjoy immediately (e.g., such as a free cup of coffee or other “treat”), or a reward that the customer is about to complete qualification for, and may need a reminder about what additional steps are required. Those skilled in the art will appreciate, upon reading this disclosure, that other messages may also be delivered to the customer at the point of interaction using features of the present invention. For example, a customer may be provided with messages regarding their current rewards point balance or other information about the status of their participation in or eligibility for rewards.

In some embodiments, methods, systems, apparatus, means and computer program products are provided to deliver real time rewards messaging and real time rewards at the point of sale during a purchase transaction, resulting in a reward amount being applied to reduce the transaction amount. These embodiments will be referred to herein generally as the “discount” embodiments, and will be described herein in conjunction with FIGS. 1-2, 4, 7 and 10 (although features may also be utilized in the embodiments described in the other Figures). The discounting embodiments generally allow a customer to receive a discount or reduction in a purchase price during the current purchase transaction, and may also include messaging informing the customer of the discount.

In some embodiments, methods, systems, apparatus, means and computer program products are provided to allow a customer to view their current rewards point balance at the point of interaction and, if eligible, allow the customer to redeem reward points during the transaction, thereby reducing the payment price. These embodiments will be generally referred to herein as the “redemption” embodiments, and will be described in conjunction with FIGS. 1-2, 5, 8 and 11 (although features may also be utilized in the embodiments described in the other Figures). The redemption embodiments generally allow a customer to choose to apply already earned reward points to a current transaction, thereby reducing the amount due in the transaction. Further, the redemption embodiments allow a customer to check their reward point balance at the point of interaction. In some embodiments, a “split tender” transaction may be performed in which the customer may redeem or use reward points to make a partial payment of the purchase balance and pay for the remaining balance using another payment methods (e.g., such as charging or debiting the remaining amount from a payment card account). In some embodiments, the customer may establish or specify their payment preferences by logging into a Website or interactive voice response (“IVR”) system and indicating how reward points should be redeemed at selected merchants. Other features will become apparent upon review of the following description and accompanying drawings.

The embodiments described herein allow for rewards to be automatically and conveniently credited to payment card accounts of customers who participate in rewards programs (either in a current transaction or in a statement), while providing appropriate messaging to the cardholder. Processing and administrative economies are realized by using a previously existing payment processing network as the vehicle for identification, messaging, and calculation and delivery of rewards. In general, little or no modification of the payment transaction authorization network or systems themselves are required, since a separate rewards system computer is associated with the payment processing network to identify, message and calculate the rebate and redemption transactions to be handled through existing mechanisms of the payment transaction authorization network or systems.

### Overview of Reward Processes and Systems

Features of some embodiments will now be described by reference to FIG. 1, in which a block diagram representation of a reward processing transaction 100 is shown. Reward processing transaction 100 is performed using a number of devices or entities interacting over one or more networks to facilitate a payment transaction involving a payment card account accessed by a payment card 102. For example, as depicted, reward processing transaction 100 involves interaction between a variety of devices or entities, including a point of sale device 104, merchant systems 106, acquirer systems 108, authorization systems 110, issuer systems 112, a reward data source 114, and a reward system 116. Those skilled in the art will recognize that a large number of devices and entities may be involved in a payment system pursuant to the present invention. For example, authorization systems 110 may process transactions from a number of different point of sale devices 104, a number of different merchant systems 106, a number of different acquirer systems 108, and a number of different issuer systems 112. For ease of exposition, only a single one of each of these devices, systems or entities is shown in the block diagram of FIG. 1.

Point of sale device 104 (also referred to herein as a “POS” device or location) may be any of a number of types of devices, and may also refer to a “point of interaction” such as Internet commerce sites that receive payment account numbers from customers who shop online, mail order or telephone (MOTO) merchants who receive payment account numbers by telephone and/or mail, and physical point of sale terminals located in brick-and-mortar retail stores. In the case of physical point of sale terminals, a payment card 102 (e.g., a credit or debit card) is presented to the terminal by a customer and read by the terminal to input the number of the payment card account to which a purchase transaction is to be charged. In the case of other types of POS locations, the payment card account number is input into the POS location by human data entry or the like. Those skilled in the art will appreciate that a physical embodiment of a payment card is not needed—for example, a “virtual” payment card may be used where the cardholder simply enters (or causes to be entered) a payment card account number.

POS device 104 may be connected to a merchant system 106. A number of different POS devices may be connected to a merchant system. Each merchant system 104 is a computer or computer system that receives transaction data from the POS devices 104 connected to it and that forwards authorization requests and requests to settle purchase transactions to an acquirer 108. In the case of an Internet shopping site, the POS device(s) and the merchant processing system may be integrated together into a single computer system. In some cases (not illustrated), POS device 104 may communicate directly with acquirer systems 106, without an intervening merchant processing system. The term “acquirer” is widely used in the payment processing field, and refers to financial institutions such as banks or other financial systems that have agreements with merchants to receive and forward purchase transaction authorizations and settlement requests on behalf of the merchants. The term “acquirer” also refers to processing agents that act on behalf of such financial institutions or systems. Each acquirer typically serves numerous merchants, and accordingly each acquirer system 108 may be in communication with numerous merchant systems 106.

In some embodiments, one or more merchant systems 106 may directly connect or communicate with authorization systems 110 (e.g., a merchant system may have the capability of transmitting and receiving authorization messages without need for communication with a separate acquirer system 108).

The term “issuer” is widely used in the payment processing field, and refers to financial institutions such as banks or other financial systems that issue payment products (such as payment card, debit card or credit card accounts, etc.) to customers or other account holders. The term “issuer” also refers to processing agents that act on behalf of such financial institutions or systems. Each issuer typically serves a number of account holders. Authorization systems 110 may be in communication with a number of different issuer systems 112.

Authorization systems 110 act to authorize transactions initiated at POS locations 104 involving payment cards associated with the authorization network. In one illustrative example, authorization systems 110 include the BankNet® network operated by MasterCard International®, which serves to facilitate authorizations of payment transactions involving MasterCard branded payment cards. Those skilled in the art will recognize that other authorization networks are also known and used for processing payment transactions (e.g., such as the payment card authorization networks operated by Visa International Service Association® or American Express®). Authorization systems 110 receives payment authorization request messages from acquirer systems 108, and processes the authorization request messages to authorize or decline a payment transaction. In some embodiments, authorization request messages may be routed to issuer systems 112 for authorization processing. Those skilled in the art will also appreciate that authorization systems 110 may also include a transaction clearing and settlement function; however, for the purpose of this disclosure, the systems 110 will simply be referred to as the authorization systems.

Embodiments as illustrated in FIG. 1 also involve a reward data source 114 in communication with authorization systems 110 and a rewards system 116. Pursuant to the embodiment of FIG. 1, reward data source 114 stores data identifying payment card accounts participating in one or more reward programs associated with authorization systems 110, as well as details about those reward programs. In some embodiments, the data stored at reward data source 114 is an extract of data from rewards system 116 generated, for example, on a batch basis (e.g., daily or on some other schedule).

In some embodiments, each reward program administered using features of the invention may include data identifying the types of transactions that qualify for a reward, as well as other eligibility criteria (such as program eligibility dates, etc.). In some embodiments, payment card accounts may qualify based on account ranges (e.g., an issuer may specify that accounts in a certain account number range are eligible for participation in a reward program), or based on individual accounts. In some embodiments, individual accounts (or account ranges) may have different levels of rebate or reward program eligibility. Pursuant to some embodiments, eligibility may be determined using statistical analysis based on prior transaction information associated with individual accounts. In some embodiments, the eligibility may be determined based on spend triggers or amounts at a participating merchant which causes the customer to become eligible for a discount at a second merchant. Further, in some embodiments, eligibility may be determined based on transactions conducted during a specific period of time (e.g., a customer who has not used their account for a while may be given a specific period of eligibility to receive a reward to encourage the customer to use their account). Other eligibility criteria will become apparent to those skilled in the art upon reading this disclosure. Reward data source 114 stores the data (or a subset of the data) needed to perform such a lookup, either on an individual account or an account range basis.

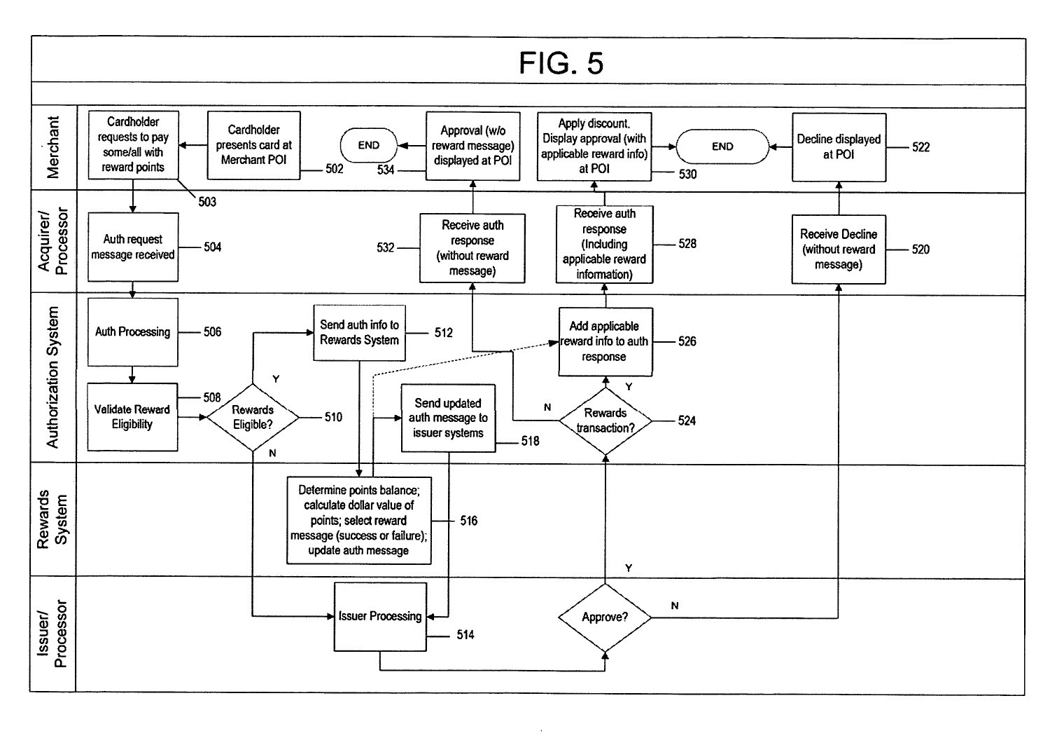

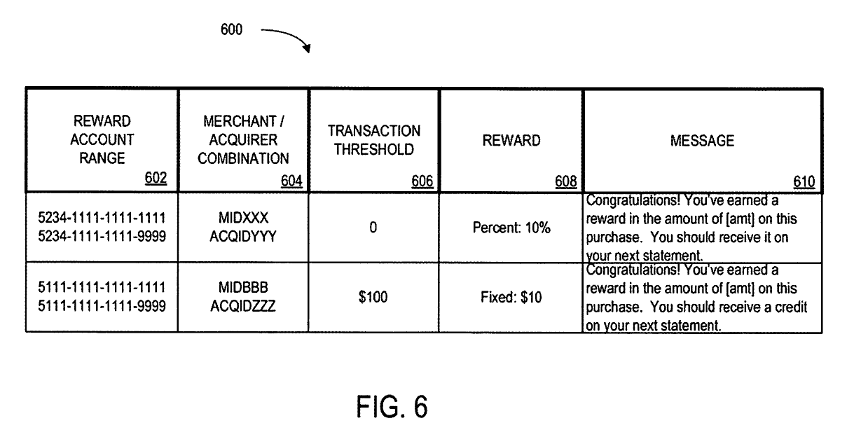

Further details of the data stored in reward data source 114 and rewards system 116 will be described below in conjunction with FIGS. 5 and 6. In general, however, the data may include participation criteria including, for example: account numbers or account number ranges, acquirer and or merchant identifiers, information identifying qualifying purchase transactions and thresholds, reward information (a fixed amount, a percentage of a transaction amount, etc.), and current status information (e.g., including each cardholder's current reward balance). Further, reward data source 114 and rewards system 116 store rewards messaging data for delivery to, receipt and display at POS location 104. In some embodiments, rewards messaging data may also be displayed to a clerk or cashier so that the clerk or cashier may verbally communicate the reward message to the customer.

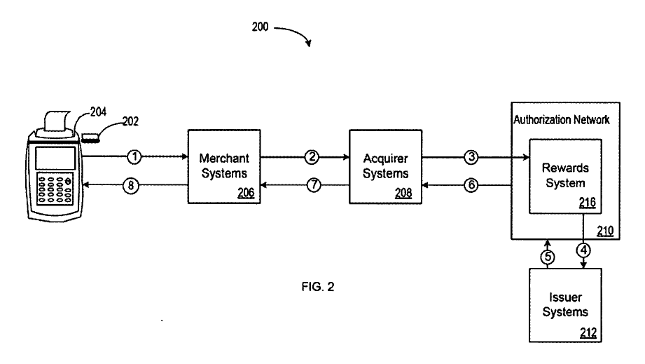

Reference is now made to FIG. 2 where a further embodiment of rewards processing 200 is shown. In the embodiment depicted in FIG. 2, processing is substantially similar to processing of FIG. 1 for the messages transmitted between the POS terminal 104, merchant systems 106, acquirer systems 108 and authorization systems 110. However, in the embodiment of FIG. 2, a rewards system 216 is included as part of the authorization systems 210 and is configured to receive an authorization request message, identify reward-qualifying transactions, and update the authorization request message before the authorization request message is transmitted to the issuer 212 for authorization. In this manner, authorization response messages associated with reward-qualifying transactions can be manipulated prior to authorization.

In particular, pursuant to some embodiments, processing at the authorization network 210 upon receipt of an authorization request message (shown as message “3”) proceeds as follows. Authorization network 210 receives an authorization request message which includes (among other items) a purchase amount, a payment card account identifier, a merchant identifier, and an acquirer identifier. Authorization network 210 passes this information to rewards system 216 for a determination of whether the requested transaction is a rewards-qualifying transaction.

A transaction may be a rewards-qualifying transaction, for example, if the payment card account identifier is participating in a rewards program, if purchases at the merchant identified by the merchant identifier (and/or the acquirer identifier) are eligible for rewards in the rewards program, and if the purchase amount is within a transaction threshold associated with the reward program. If these conditions are met, rewards system 216 causes the authorization request message to be updated to include an updated payment amount and a rewards message. The updated payment amount is calculated based on the reward program rules contained in the rewards system 216. For example, if the reward program rules specify that a fixed (e.g., $10) amount is to be credited to the purchase transaction, the updated payment amount inserted into the authorization request message will be equal to the original payment amount less the fixed reward amount. Other rules may be applied, depending upon the transaction information and program eligibility (e.g., if the transaction includes a point redemption request, rules related to points redemption may be applied, etc.).

The updated authorization request message is then transmitted to issuer 212 for authorization (shown as message “4”). Issuer 212 then performs authorization processing on the transaction based on the updated payment amount (e.g., does the account associated with the payment card account identifier have sufficient funds available to complete the transaction based on the updated payment amount?, etc.). If issuer 212 authorizes the transaction, an authorization response message (shown as message “5”) is transmitted back to authorization network 210. The authorization response message, in some embodiments, includes the original payment amount and the updated payment amount as well as any rewards messaging selected by the rewards system 216.

Authorization network 210 routes the authorization response back to the acquirer 208 (shown as message “6”) which passes the authorization response to the merchant systems (shown as message “7”). Merchant systems 206, in some embodiments, may update settlement records to indicate that the purchase transaction involved a reward applied in the transaction. In some embodiments, merchant systems 206 may operate to identify whether the transaction further qualifies for merchant-specific rewards. For example, a merchant may offer certain qualifying transactions a reward or coupon based on qualifying transaction details. This information may be appended to, or separate from, the authorization response message.

Merchant systems 206 pass the authorization response message (shown as message “8”), and, in some embodiments, any merchant-specific reward details back to POS terminal 204 to complete the transaction. POS terminal 204 displays and/or prints the reward messaging in the authorization response message to provide instant feedback to the customer. In some embodiments, the POS terminal 204 completes the transaction based on the updated payment amount calculated by rewards system 216. As an illustrative example, if the original purchase amount was $100, and the transaction was identified as a reward-qualifying transaction with a fixed $10 reward, the POS terminal 204 may display $90 as the final purchase price. In some embodiments, tax is calculated based on either the final purchase price or the original purchase amount, depending on the rules of the relevant tax jurisdiction. In some embodiments, the customer is presented with a sales ticket for signature or other approval for the final purchase amount (in the example, the customer is presented with a receipt or display asking for approval to complete the $90 purchase amount). In this manner, customers are able to enjoy instant feedback of rewards transactions, and further, instant realization of reward amounts during reward-qualifying transactions.

In the embodiments depicted in FIGS. 1 and 2, the rewards system 116, 216 is shown as a separate system or data source. In some embodiments, the rewards system may be a database in communication with authorization systems 110, 210 and storing data identifying rewards programs, reward details, and qualifying information. Further, while a rewards data source 114 is shown in FIG. 1 separate from rewards system 116, the rewards data source 114 may be a data extract from rewards system 116 or a linked database pulling segments of data from rewards system 116. Other data implementations may also be used so long as authorization systems 110, 210 have access to current rewards program data, reward details, and qualifying information.

To illustrate features of some embodiments, examples will now be provided for the rewards messaging, discounting and points redemption embodiments.

### Reward Processing Example—Messaging Embodiments

For the purpose of describing features of some embodiments, an illustrative reward transaction example using the network of FIG. 2 will now be presented. In particular, an example of embodiments associated with rewards messaging will first be provided. In the illustrative example, a customer who has been issued a payment card 202 will use the payment card to make a purchase at a POS location 204. The payment card 202 is associated with a payment card account that is eligible to participate in a rewards program administered using features of the present invention.

In the illustrative example, the customer is making a purchase at a retailer for a total purchase price of $100.00. The customer is using a payment card associated with a payment account that is eligible to receive a statement credit of 10% of the purchase price. The transaction proceeds as follows. First, the customer swipes her payment card (or otherwise presents it for the purchase) at POS location 204. POS location 204 transmits the transaction information (as message “1”) to merchant systems 206. The transaction information includes, among other data items, the transaction amount and the payment card account information. This data is used to create an authorization request for transmission to acquirer systems 208 (as message “2”). In the illustrative example, the payment card is a MasterCard® credit card, and the authorization request is formatted and transmitted in a MasterCard® authorization message format The authorization message may also include information identifying the merchant and/or the acquirer (e.g., such as by using a unique “merchant identifier” and a unique “acquirer identifier”).

The authorization request message is transmitted (as message “3”) to authorization systems 210 and authorization systems 210 operate to make a determination of whether the payment account identifier contained in the authorization request message is participating in a rewards program (e.g., by comparing the account identifier with an account range or account numbers contained in the rewards system 216). If the payment account is participating in a rewards program, the transaction information is compared to other data in the reward system 216 to determine if the current transaction qualifies for a reward and, if so, the amount of the reward (or details about the reward if the reward is a “treat” or service such as a free cup of coffee, or a free gift wrap) and/or information about an impending reward if there are still further spends or visits required to fully qualify for the reward. In the example, the rewards system 216 indicates that the customer is eligible for a 10% statement credit. The rewards system 216 calculates the amount of the statement credit (in this example, it is $10), and identifies the appropriate rewards messaging to be communicated to the customer (e.g., for display on a display screen, printing on a receipt, and/or verbal communication by a cashier or teller). In some embodiments, the rewards messaging may be inserted into the authorization request message prior to forwarding (via message “4”) to the issuer systems 212 for approval. In other embodiments, the authorization message is transmitted (at “4”) to issuer systems 212 for approval and then the appropriate rewards messaging is appended to the authorization response message (forwarded to the acquirer systems at “6”).

In either event, the reward messaging data is provided in the authorization response message that is transmitted to the acquirer systems 208 at “6” so that the appropriate rewards messaging can be displayed to the customer at the POS terminal 204 (e.g., by display on a display screen and/or by printing on a receipt). In this example, the rewards messaging will include messaging informing the customer that they have earned a $10 credit that will be credited to the customer's next statement.

The reward messaging inserted into the authorization response may be the actual text message that will be displayed or communicated to the customer (such as “You will receive a $10 credit on your next statement”) or the reward messaging inserted into the authorization response may be a reward message identifier that is returned to the POS system. The reward message identifier may then be used by the POS system to calculate, look up, display, print, and/or orally present (by a cashier or teller) the full reward messaging. The authorization response message, including any appended rewards messaging, is transmitted from authorization systems 210 to the acquirer 208 (shown as message “6”) for transmission to merchant systems 206 (as message “7”) for ultimate delivery to POS terminal 204 (as message “80”). In some embodiments, merchant systems 206 may operate to identify whether the transaction further qualifies for merchant-specific rewards. For example, a merchant may offer certain qualifying transactions a reward or coupon based on qualifying transaction details. This information may be appended to, or separate from, the authorization response message.

POS terminal 204 parses the authorization response (and any merchant-specific rewards messaging) and retrieves the reward messaging and displays and/or prints the reward messaging on a display and/or on a printed receipt. In this manner, the customer is able to enjoy instant notification of a reward transaction (e.g., rather than having to wait until receipt of the customer's next statement to see which purchase transactions qualified for a reward). Those skilled in the art will appreciate, upon reading this disclosure, that a wide variety of different messages may be transmitted to POS terminals along with authorization response messages pursuant to some embodiments.

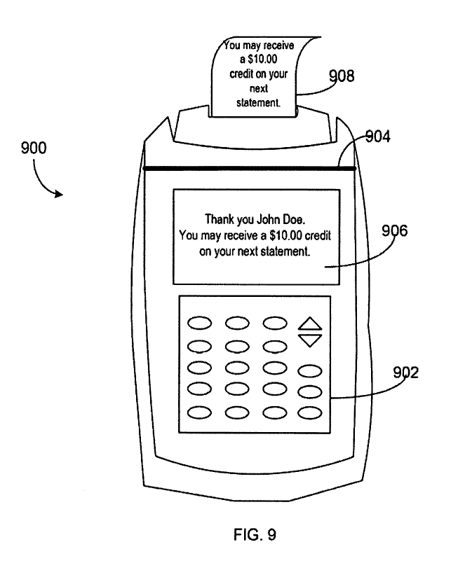

An example of a POS terminal 900 which displays and prints reward messaging pursuant to some embodiments is shown in FIG. 9. As depicted, the POS terminal 900 includes a keypad or entry portion 902, a display screen 906, a card swipe or card reader 904 and a printer for printing a receipt 908 including messaging pursuant to some embodiments of the present invention.

### Reward Process Example—Discounts

Pursuant to some embodiments, similar processing may be utilized to deliver real-time rewards or “discounts” to the current transaction. An illustrative transaction resulting in such a discount will now be described by again referring to FIG. 2. In a discount transaction, processing begins in the same manner as described above with respect to the messaging embodiment, and the processing and content of messages “1” through “3” are generally the same as discussed above. In the discounting example, the customer is again making a $100 purchase, however, the customer's payment card account is one that participates in the discounting embodiment of the present invention, and the purchase is one that qualifies the customer for an instant $10 discount on this purchase.

The determination of eligibility for the discount is made by the rewards system 216 upon receipt of the authorization request message (shown as message “3”). Upon determining that the transaction is eligible for a discount, pursuant to some embodiments, the authorization request message is updated to indicate that it is a discount transaction, and that the amount of the discount is $10. This updated authorization request message is then forwarded to the issuer (or issuer processor) for authorization as discussed above. In the illustrative example, the issuer authorizes the transaction, and an authorization response message is transmitted back to the POS terminal. In some embodiments, the rewards messaging that is to be displayed on the POS terminal 204 is appended to the authorization response message by the authorization network 210.

In some embodiments, the messaging is represented by a message indicator that is then translated by the POS terminal or merchant systems 206 to cause the appropriate messaging to be displayed to the customer on a display screen of POS terminal 204, printed on a receipt printed by the POS terminal 204, and/or read or communicated by a cashier. For example, in some embodiments, a “promo code” or other field is included in the authorization response message which is inserted into the authorization response message by the rewards system or authorization system. The promo code is used by the POS terminal or merchant systems 206 to apply or calculate a discount amount at the point of interaction. In these embodiments, the full transaction price may be authorized by the issuer (e.g., in the illustrative embodiment, the issuer may authorize the full $100 transaction), and full transaction price less the discount amount is then cleared and settled between the acquirer and the issuer after the transaction.

In the illustrative example, in embodiments using a “promo code”, the customer is presented with messaging informing her that her purchase price has been reduced by $10 as a result of an instant discount. The customer's payment card account is charged $90, and information about the discount is printed on a receipt and, in some situations, displayed on a display screen of the POS terminal. The acquirer and the issuer settle after the transaction to ensure the merchant is paid the full $100 (less any interchange and fees). In the illustrative example, in embodiments not using a “promo code”, the authorization system forwards an authorization request message to the issuer for the purchase amount less the discount (or $90).

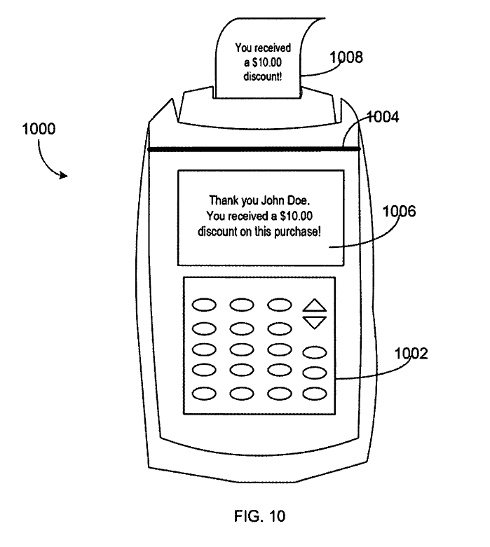

An example of a POS terminal 1000 that displays messaging in a discounting embodiment is shown in FIG. 10. As shown, POS terminal 1000 may have a keypad portion 1002, a display screen 1006 (for displaying the rewards messaging communicated via the authorization response message), a card reader portion 1004, and a printer for printing a receipt 1008 (including the rewards messaging communicated via the authorization response message). In this manner, embodiments allow customer to enjoy instant discounts (applied in the current transaction) based on their participation in reward programs administered by the system.

### Reward Processing Example—Point Redemption Embodiments

Pursuant to some embodiments, the system of FIG. 2 may be used to allow cardholders to use reward points at the point of interaction to fund part or all of a purchase amount. In a point redemption transaction, processing begins in the same manner as described above with respect to the messaging embodiment, where the customer presents a payment card at a merchant point of interaction to make a purchase. Assume, for the purpose of illustration, that the customer is making a purchase that totals $100. In the example, the customer has sufficient points in her reward account to cover the entire purchase price.

In some points redemption embodiments, the point of sale or point of interaction terminals or devices include a menu item or button that allows the customer to indicate a desire to pay part or all of the purchase amount using reward points (e.g., the customer may be prompted: “Do you wish to apply reward points to this transaction?”). If the customer indicates a desire to apply reward points to the transaction (for either a portion or the total purchase price), an authorization request message is constructed and transmitted (at “1”) from the POS to merchant systems 106 and includes an indicator that the customer wishes to redeem reward points and, in some embodiments, the dollar amount that the customer wishes to redeem. In some embodiments, the customer may be presented with options to: use all available points for the transaction (if there are insufficient points to make the purchase, the remainder will be charged to the payment card, e.g., using a “split tender” capability of the merchant systems), use partial points as indicated by the points amount (or dollar equivalent) entered by the customer into the POS terminal (again, if there are insufficient points, the balance is charged to the payment card).

In the illustrative example, the customer chooses to use all available points for the transaction (i.e., she wishes to pay the total purchase price using rewards points). This information is included in the authorization request message, and processing continues as discussed above (e.g., messages “2” and “3” are similar to those above), and the authorization systems 210 receive the authorization request message and process the request message using the rewards systems 216 to determine if the transaction is rewards eligible. In this embodiment, further processing is performed to determine whether the customer has a rewards points balance that is sufficient to perform the rewards transaction requested by the customer. In the example, the customer has sufficient points to cover the balance. In some embodiments, if sufficient points exist, the points for the transaction are deducted from the points balance and the authorization request message is updated. In some embodiments, if the total purchase price will be made using rewards points, no further issuer processing may be needed, and the authorization systems 210 may create and transmit an authorization response message back to the POS terminal. Again, appropriate rewards messaging may be included in the authorization response message for display to the customer.

In this manner, embodiments allow customers to easily and conveniently redeem points for purchases. There is no need for the customer to redeem points through a catalog (although this may still be an option for customers) and they can enjoy immediate benefit and access to their reward point balance.

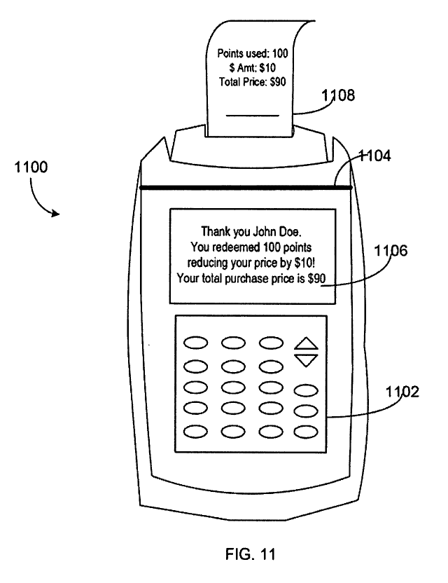

An example of a POS terminal 1100 that displays messaging in a points redemption embodiment is shown in FIG. 11. As shown, POS terminal 1100 may have a keypad portion 1102, a display screen 1106 (for displaying the rewards messaging communicated via the authorization response message), a card reader portion 1104, and a printer for printing a receipt 1108 (including the rewards messaging communicated via the authorization response message). Further aspects of the points redemption embodiments will be described further below in conjunction with FIGS. 5, 8 and 11.

### Rewards Messaging Process Flow

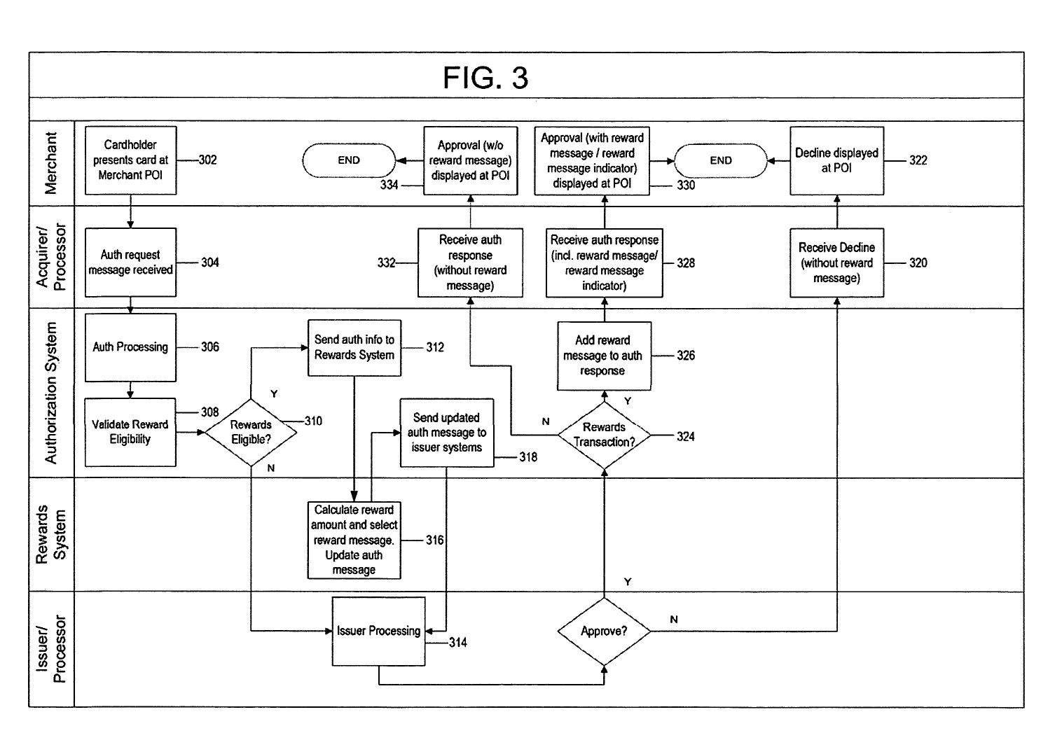

Further details of the rewards messaging process will now be described by reference to FIG. 3, where a reward messaging process 300 according to some embodiments is shown. Reward messaging process 300 may be implemented using, for example, the system shown in FIG. 2. Reward messaging process 300, in some embodiments, begins at 302 where a customer initiates a purchase transaction at a merchant point of sale (either a physical point of sale, mail order, telephone, Internet, or the like). For example, the customer may take one or more products to a checkout location and present a payment card for the purchase.

Processing continues at 304 where an authorization request is transmitted from the point of sale to an acquirer system and then to 306 where the authorization request is transmitted to an authorization system for authorization processing. The authorization request, in some embodiments, may be the standard authorization request message used by a payment system. For example, in embodiments implemented using the MasterCard payment card networks, the authorization request message may be the standard “0010” authorization request which includes transaction details including the payment card account number, the transaction purchase price, the merchant identifier, the acquirer identifier, a transaction date and time, etc. Processing continues at 308 where the authorization system performs initial reward processing on the transaction to, for example, validate that the payment card account associated with the transaction is eligible for reward processing.

For example, a transaction may be eligible for reward processing if the payment account number is in an account number range (e.g., as established by the payment account issuer) that is participating in rewards transactions. If the payment account number is rewards eligible, processing continues at 312. If the account number is not rewards eligible, processing continues to 314 where the normal authorization processing of the payment network and issuers are applied.

If the transaction is eligible for rewards processing, processing continues at 312 where the authorization information (in the authorization request message) is transmitted to the rewards system for processing. As discussed above, the rewards system may be a part of the authorization systems or it may be separate. In either event, processing continues at 316 where the rewards system, using information contained in the authorization request message, looks up the appropriate rewards rules for the transaction (e.g., based on the payment card account number and other transaction details) and calculates the reward amount and selects the appropriate reward messaging to transmit back to the POS terminal. The reward amount and messaging are appended to the authorization message, and processing continues at 318 where the authorization systems forward the updated authorization request message to the issuer (or issuer processor) associated with the payment card account number in the authorization request message. At 314, the issuer performs standard authorization processing to determine if the transaction can be authorized.

At 314, the issuer or issuer processor compares details of the transaction to information about the payment card account to determine if the transaction may be authorized. If the transaction is declined, processing continues at 320 where an authorization denial message is transmitted back to the merchant point of sale at 322. In situations where the authorization response record includes a so-called “hard decline”, the appropriate decline code is the only literal displayed and the record is not captured in the terminal. Accordingly, the cardholder is not entitled to receive the rebate based on the decline. In some embodiments, in situations where the authorization response record includes a so-called “soft decline”, a message such as “call call center” or similar literal may be included in the authorization response and displayed at the point of sale.

If processing at 314 indicates that the transaction may be authorized, an authorization response message is created, and routed back to the authorization system at 324. The authorization system determines if the authorization response is associated with a rewards-eligible transaction and, if so, processing continues at 326 where an appropriate reward message is appended to the authorization response. In some embodiments, a reward message indicator may be identified at 316 and the actual message text may be appended at 326. In some embodiments, the reward message indicator may be appended at 326 for later translation into message text by the POS terminal at 330. Processing continues at 328 where the acquirer systems receive the authorization response message (including the reward messaging or messaging indicator), and then continues at 330 where the authorization response is routed to the POS terminal for display and/or printing for the customer.

In some embodiments, processing at 330 may include the operation of merchant systems to identify whether the transaction further qualifies for merchant-specific rewards. For example, a merchant may offer certain qualifying transactions a reward or coupon based on qualifying transaction details. This information may be appended to, or separate from, the authorization response message.

If processing at 324 indicates that the transaction in the authorization response message is not rewards-eligible, processing continues at 332 where the acquirer systems receive an authorization response message that does not include any rewards messaging. The authorization response message is transmitted to the POS terminal to display the approval (without rewards messaging, unless merchant-specific rewards are added by the merchant systems) and transaction completion. Again, an example of rewards messaging at the POS terminal are shown in FIG. 9.

### Discounting Process Flow

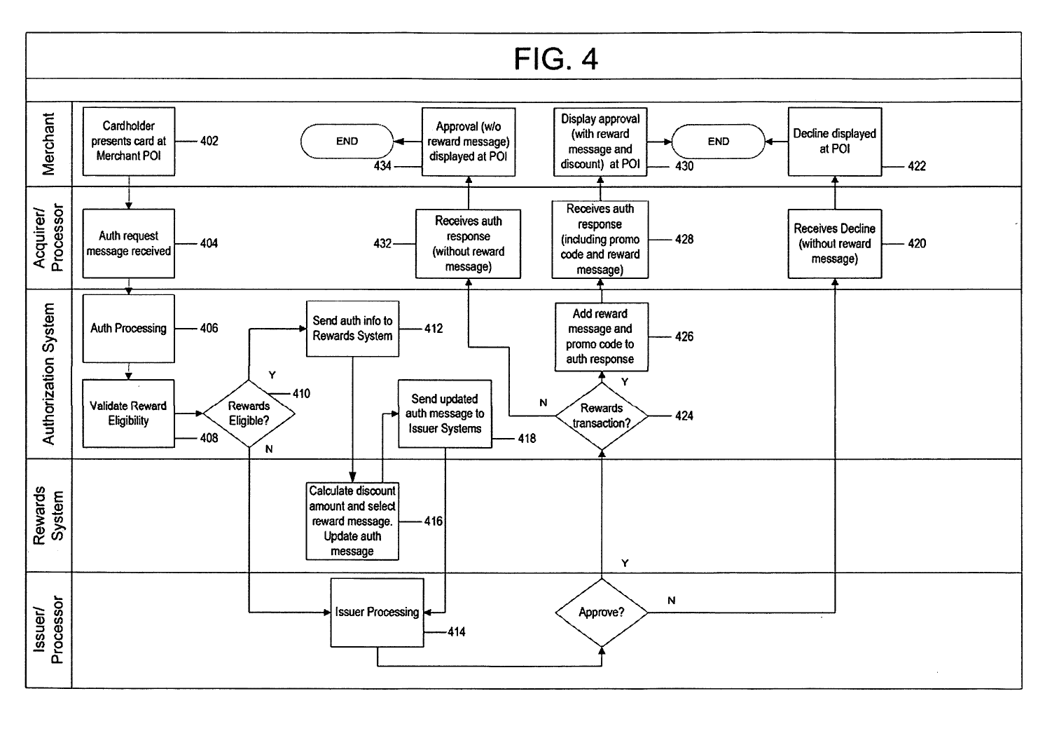

Reference is now made to FIG. 4, where a discounting process 400 is shown pursuant to some embodiments. Discounting process 400 may be implemented using, for example, the system shown in FIG. 2. A number of process steps in the discounting process 400 are similar to the rewards messaging process 300 of FIG. 3 and, for brevity, only the steps having differences will be described.

Discounting process 400 includes receiving, by the authorization system, an authorization request message at 406 and performing standard authorization processing on the message. Further, the message is checked at 408 to determine if it is a rewards-eligible transaction (e.g., by checking the payment card account number to see if it is a number or in a range of numbers participating in a rewards program). If the transaction is rewards eligible, processing continues at 412 where the authorization request message is transmitted to the rewards system for processing.

In a discounting process, such as the process 400, reward processing includes processing at 416 including calculating a discount amount associated with the transaction by applying one or more reward rules associated with the payment account number. For example, a number of different reward rules associated with discounts may be established and applied using the rewards system. For example, some rules may indicate that a transaction is eligible for a flat discount (e.g., $5 off a purchase price greater than a certain amount) or a percentage of the purchase price (e.g., 10% off the total purchase price). Those skilled in the art will appreciate that a wide range and variety of different rules may be applied to calculate a discount for a given transaction. Processing at 416 may also include the selection of an appropriate rewards message associated with the discount. Processing at 416 includes updating the authorization request message to include the discount amount and any related messaging.

Processing continues at 418 where the authorization system forwards the updated authorization request (with the discount amount) to the issuer (or issuer processor) systems for issuer processing. In some embodiments, the issuer authorizes the transaction based on the total purchase price less the discount amount (e.g., if the total purchase price is $100 and a $10 discount is to be applied, the issuer will determine if the payment card account has sufficient funds to cover the $90 adjusted purchase price). If the transaction is authorized, processing continues at 424 where the authorization response is routed back to the authorization systems. If the transaction is not a rewards transaction, processing continues at 432 and 434 where the transaction is completed as normal. If the transaction is rewards-eligible, processing continues at 426 where, in some embodiments, the rewards messaging (or a message identifier) are appended to the authorization response message for transmission to the POS terminal. At 430, the authorization approval is displayed for the cardholder at the point of interaction along with the rewards messaging and information about the discount. Again, an example of a POS terminal displaying and printing information associated with a discount transaction are shown in FIG. 10.

### Points Redemption Process Flow

Reference is now made to FIG. 5, where a points redemption process 500 is shown pursuant to some embodiments. Points redemption process 500 may be implemented using, for example, the system shown in FIG. 2. A number of process steps in the points redemption process 500 are similar to the rewards messaging process 300 of FIG. 3 and, for brevity, only the steps having differences will be described.

Points redemption process 500 begins at 502 where a cardholder presents a payment card to make a purchase at a POS terminal (or point of interaction). In some embodiments, processing continues at 503 where the cardholder, interacting with the POS terminal, indicates a desire to pay for some or all of the purchase price using reward points.

Alternatively (or in addition), pursuant to some embodiments, some or all of the processing at 503 may be automated based on rules previously established by the customer. For example, customers may log into a Website (or call in to an interactive voice response unit or the like) and view (or hear) their reward point balance and manage their rewards point account. In some embodiments, as part of managing their reward point account, customers may specify one or more point redemption preferences. For example, a customer may specify redemption rules to make point redemption at a point of interaction proceed according to their preferences. As a specific example, a customer may select from a list of merchants and establish rules and preferences for how reward point redemption is to be handled during transactions at those merchants. A customer may set up a rule, for example, indicating that for transactions at a specific merchant, that reward points should automatically be applied to purchase transactions. This allows the customer to avoid the need to enter any reward redemption instructions at the point of interaction. Instead, any available reward points will automatically be redeemed during qualifying transactions at that merchant. Pursuant to some embodiments, the customer may specify other reward redemption preferences. For example, the customer may indicate that if there are insufficient reward points available to fully pay for a purchase transaction, that any remaining balance owed in the transaction should be charged to the customer's payment card account presented during the transaction. In this manner, customers can establish rules and preferences that suit their particular needs and avoid the need for additional processing (e.g., such as specifying points at 503) during a purchase transaction.

Pursuant to embodiments in which processing at 503 includes the customer specifying the number of points to be redeemed, information about the purchase transaction, and the cardholder's desire to use points, are included in an authorization request message that is transmitted to acquirer systems at 504, and then to authorization systems at 506 where the authorization systems begin authorization processing of the transaction.

In embodiments in which the customer has previously established point redemption rules (e.g., by specifying those rules on a Website or the like), the authorization request message transmitted at 504 may not include any information regarding points redemption.

Authorization processing begins at 508 where a determination is made whether the transaction is reward eligible (again, by consulting a table of qualifying account numbers or account number ranges). If the transaction is rewards eligible, processing continues at 512 where the authorization request message is transmitted to the rewards system for processing.

Rewards system processing begins at 516 where several actions are taken, including determining whether the cardholder has sufficient reward points available to perform the action requested by the cardholder. Pursuant to embodiments in which point information was not specified at 503, processing at 516 may include determining whether the cardholder has previously specified any reward point redemption rules (e.g., has the cardholder indicated whether points should automatically be redeemed for purchases at this merchant? If so, how many points should be used? etc.). Processing at 516 may also include converting the dollar amount of the transaction (or the dollar amount requested to be redeemed by the cardholder) into points using, for example, a rewards point conversion table or conversion factor, and then determining whether sufficient rewards points for the transaction are available in the cardholders reward account. If sufficient points are available, the cardholder's reward account is reduced by that amount, and the authorization message is updated to reflect the usage of reward points (e.g., by calculating an updated transaction amount equal to the original transaction amount less the dollar equivalent of points being used). Any associated rewards messaging may also be identified at this point.

In some embodiments, if there are insufficient reward points in the cardholders reward account to comply with the cardholder's request, a reduced amount of points may be applied if possible (and appropriate messaging indicating this reduced amount may be appended to the updated authorization message to inform the cardholder).

In some situations, a cardholder may “overdraw” reward points (e.g., by completing two rewards transactions in quick succession such that the rewards system is unable to update its records before the second transaction occurs). Such overdraws may be prevented using any of a number of different techniques. For example, a cardholder (pursuant to their account terms and conditions) may agree to pay for any overdrawn points pursuant to a pre-established point to dollar amount conversion factor. As another example, the overdrawn points may be carried forward as a negative points balance on the cardholder's next account statement.

Processing continues at 518 where the authorization systems route the updated authorization request message to the issuer (or issuer processor) of the payment card account associated with the request for authorization. If points were available to reduce the purchase price, the issuer may authorize the transaction based on the updated transaction amount. In some embodiments, if sufficient points were available to reduce the updated transaction amount to $0, issuer processing may not occur, and processing may go directly from 516 to 526 (e.g., the authorization system effectively “stands in” for the issuer to authorize the transaction based on rewards points alone). In some embodiments, some or all transactions (including transactions which will involve a $0 transaction as a result of points being redeemed) are routed to the issuer for authorization.

If issuer processing is still required (e.g., the updated transaction amount is greater than $0), processing continues at 514 where the issuer (or issuer processor) performs authorization processing on the updated transaction amount. If the authorization is approved, processing continues at 524 and 526 where appropriate reward messaging is added and a promo code or indicator is added to the authorization response message to alert the POS terminal that the transaction is to be finalized using reward points and an updated transaction amount. For example, the promo code or flag may cause the POS terminal to update the purchase price in the terminal to equal the updated transaction amount (the original transaction amount less the dollar equivalent of points redeemed) so that the cardholder is only asked to sign the transaction receipt for the updated transaction amount. Again, an illustration of the messaging displayed and/or printed at the POS are shown in FIG. 11.

The authorization message transmitted from the rewards system to the issuer systems may include a variety of different data elements to accommodate reward processing pursuant to some embodiments. For example, the dollar amount in the original authorization request may be moved to a field in the updated authorization request message containing the “Original Authorization Amount”. The actual amount to be authorized may be moved to a field in the updated authorization request containing the “Authorization Amount”. In a discount transaction, a “discount code” may be inserted into the updated authorization request message containing the “Discount Code”. The rewards messaging may be included in the updated authorization request message in a message literal field (containing the actual messaging) or it may be represented by a message identifier (which is used by the merchant systems to insert the appropriate message literal). In a discount transaction, the amount of the discount may be inserted into a field of the updated authorization request containing the “Discount Amount”. Those skilled in the art will appreciate that other fields and data may be used to create an updated authorization request (and/or authorization response) that contains sufficient data to process, track, and manage rewards messaging, discount, and rebate transactions pursuant to the present invention.

Pursuant to some embodiments, additional clearing messages may also be provided in a points redemption transaction to settle between merchants/acquirers and issuers. In one embodiment, a first presentment is provided with a new transaction type indicating that the transaction involved a points redemption. The clearing message may include interchange and any applicable processing fees. In a second embodiment, an invoicing presentment message is created which causes a settlement between the acquirer and the issuer for the points redemption balance. That is, in some embodiments, the merchant/acquirer may need to separately settle with the issuer for the dollar equivalent of the points redeemed during a points redemption transaction to ensure that the merchant/acquirer receives full payment for the transaction. A similar clearing process may be used for the discounting embodiments described herein.

Pursuant to some embodiments, the POS terminals and devices used in a points redemption transaction may need additional functionality to support points redemption. For example, POS terminals may require an input allowing customers to select points redemption as a payment option. Further, POS terminals may need to be configured to recognize additional amount fields in authorization response messages (e.g., to recognize the “updated transaction amount” as the amount to invoice the customer). Those skilled in the art will appreciate that other terminal configuration changes may also be required, but are within the skill of those in the art.

For each of the embodiments disclosed herein, customers can view, for example, the discounted savings, statement credits, treats, and point redemptions on the POS terminal and printed receipt display immediately. In addition, the customer's statement will reflect the discount amount or points redemption amount. In some embodiments, the way in which discount information appears on the cardholder statement is at issuer discretion. Further, customers may view their balance and rewards information by logging into a Website or other information portal.

These embodiments support an approach that uses payment card account number ranges and merchant ID data elements for the identification of participating merchants and specific customer segments who qualify for a reward, a discount, or a points redemption. In some embodiments, issuers, processors, merchants or manufacturers could fund some or all of the reward, discount or points redemption. In some embodiments, the use of product UPC or SKU information which targets specific merchandise for a discount may be supported. Further, specific merchandise items can be targeted through the use of “Promotion Codes” populated in a Promotion Code field of the authorization request record.

Reference is now made to FIG. 6 where a database diagram illustrating portions of a rewards datastore pursuant to some embodiments of the present invention is shown. As shown, a rewards datastore (such as, for example, rewards system 216 of FIG. 2) stores data identifying one or more reward account ranges 602, one or more merchant/acquirer combinations, transaction thresholds 606, rewards 608, and reward messages 610. For example, in some embodiments the eligibility for reward programs may be defined based on payment card account ranges (or specific account identifiers), the merchant locations at which rewards may be earned, and qualifying transaction thresholds. Further, the terms of rewards earned in qualifying transactions may include fixed rewards or percentage discounts or complementary services and offers. Different reward messages may be stored in the datastore for insertion into authorization response messages for delivery to merchant point of sale locations for ultimate display or communication to customers. Those skilled in the art will appreciate that other qualifying conditions and program specifications may also be included in rewards datastore to administer and deliver rewards messages.

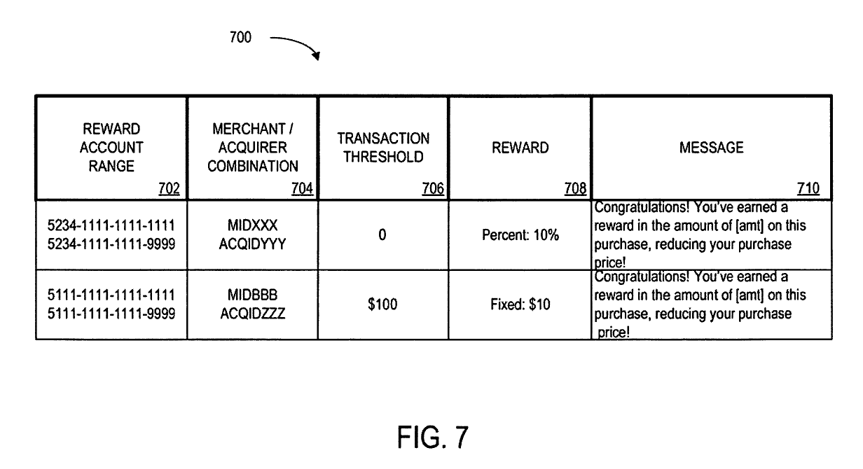

Reference is now made to FIG. 7 where a further database diagram illustrating portions of a rewards datastore pursuant to some embodiments is shown. As shown, a rewards datastore (such as, for example, rewards system 216 of FIG. 2) stores data identifying one or more reward account ranges 702, one or more merchant/acquirer combinations, transaction thresholds 606, rewards 708, and reward messages 710. For example, in some embodiments the eligibility for reward programs may be defined based on payment card account ranges (or specific account identifiers), the merchant locations at which rewards may be earned, and qualifying transaction thresholds. Further, the terms of rewards earned in qualifying transactions may include fixed rewards or percentage discounts. Different reward messages may be stored in the datastore for insertion into authorization request messages for delivery to the issuer for authorization (and then for delivery to merchant point of sale locations via an authorization response message for ultimate display or communication to customers). In the embodiment depicted in FIG. 7, the reward messaging indicates a reward earned and applied at the point of interaction during the current transaction. Those skilled in the art will appreciate that other qualifying conditions and program specifications may also be included in rewards datastore to administer and deliver rewards messages.

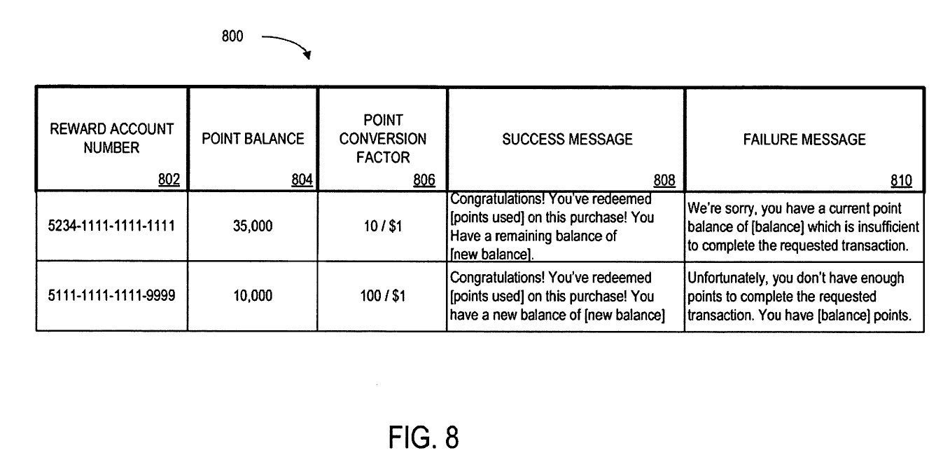

Reference is now made to FIG. 8 where a further database diagram illustrating portions of a rewards datastore pursuant to some embodiments is shown. In the illustrated embodiment, a reward points database is shown for use with the points redemption embodiments described herein. As shown, a rewards datastore (such as, for example, rewards system 216 of FIG. 2) stores data identifying one or more reward accounts 802, individual account point balances 804, point conversion factors 806, and success 808 and failure 810 messages. The data shown is for illustrative purposes only—those skilled in the art will appreciate that additional or substitute data fields may be used.

In the illustrated database table, each participating account is associated with a rewards point balance 804 which represents the current points balance for each account holder. In some embodiments (including in the embodiments depicted in FIGS. 6 and 7), this information may be updated nightly or in real time, and may include a data feed from one or more issuer processors or other entities to ensure the data is up to date. One or more point conversion factors may also be provided so that the rewards system can accurately convert from points to dollars and vice versa in order to calculate an updated transaction amount during rewards processing. In some embodiments, success and failure messages may be provided (and customized by rewards program sponsors) to provide accurate and informative feedback to customers engaging in points redemption transactions. These messages are appended to or inserted in authorization response messages during transaction processing for delivery to the point of interaction for display and/or printing for a cardholder upon completion of a transaction. A number of different messages may be provided to provide detailed receipt messaging. For example, the number of points used may be communicated, along with the cash equivalent value and any remaining points balance (and their cash equivalent value).

In some embodiments, individual accounts may be targeted and a look-up may not need to be performed. In some embodiments, individual accounts may have different levels of rebates, discounts or point redemption. Embodiments may be tailored to the individual account level to meet the needs of merchants and issuers.

In some embodiments, different types of messaging may be provided. For example, in some embodiments, cardholders shopping at selected merchant locations may be presented with “instant treats” or offers where the reward messaging includes an offer such as “You earned a free coffee at our coffee bar! Take this receipt to the coffee bar today to receive your treat.”. Other instant treats or offers may be provided.

Pursuant to some embodiments, a rebate, reward, or discounting settlement or clearing process may also be utilized to ensure that the merchant is compensated for the appropriate value of a transaction, the consumer is debited the appropriate amount, and the rebate, reward, or discount funding entity (or entities) is/are debited in the amount of the rebate, reward or discount. For example, in some embodiments, at settlement, a rebate clearing message or record may be created. For example, some merchants perform reconciliation and batch settlement file creation on a daily or other regular basis. Upon completion of this batch settlement file creation, the batch file is sent to the acquirer for subsequent transmission to the payment network. In some embodiments, any rebate, reward, or discount transactions may be included and appropriately identified in this batch settlement file. In some embodiments, the reconciliation or settlement between parties for the amount of the rebate, reward or discount may be performed using a payment message such as the payment messages disclosed in our co-pending, commonly assigned U.S. Patent Application Ser. No. 60/911,341, the contents of which are hereby incorporated by reference in their entirety herein for all purposes. In embodiments in which the merchant is funding the offer, no additional reconciliation may be needed.

Although the present invention has been described with respect to example embodiments thereof, those skilled in the art will appreciate that various substitutions or modifications may be made without departing from the spirit and scope of the present invention. For example, the processes have been described with a “payment association” or “authorization systems” such as the MasterCard payment brand and their BankNet® authorization systems. Those skilled in the art will appreciate that other entities may also operate some or all of the process steps (including, for example, closed payment networks, regional or local payment networks, or the like). Further, a “payment card” or “credit card” has been discussed. Those skilled in the art will appreciate that embodiments may be used in conjunction with other payment devices such as stored value cards, gift cards, ACH transactions, checks, debit cards, or the like.

Further, each of the embodiments disclosed herein may be used in conjunction with each other. For example, a transaction may include aspects of reward messaging, discounts and points redemption or some combination thereof. Further, pursuant to some embodiments, individual accounts or account ranges may have different levels of rebates, discounts, types of reward messages, and point redemption rules.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, from a point of interaction, an authorization request message identifying a requested purchase transaction, said authorization request message including data identifying a payment account identifier and a purchase amount;
determining that said payment account identifier is eligible for a reward and selecting a reward message associated with said reward; and
transmitting an authorization response message including said reward message to said point of interaction for communication to an account holder.

2. The method of claim 1, further comprising:
forwarding said authorization request message to an account issuer for authorization prior to said determining that said payment account identifier is eligible for a reward.

3. The method of claim 1, further comprising:
forwarding said authorization request message to an account issuer for authorization subsequent to said determining that said payment account identifier is eligible for a reward.

4. The method of claim 3, further comprising:
calculating an updated purchase amount based on a qualifying reward amount prior to said forwarding said authorization request message to said account issuer, wherein said account issuer authorizes said requested purchase transaction based on said updated purchase amount.

5. The method of claim 4, wherein said transmitting an authorization response message includes transmitting said updated purchase amount to said point of interaction.

6. The method of claim 5, further comprising:
completing said purchase transaction based on said updated purchase amount.

7. The method of claim 1, wherein said determining that said payment account identifier is eligible for a reward further comprises:
performing an account range lookup to determine if said payment account identifier is in an account range eligible for a reward.

8. The method of claim 1, wherein said determining that said payment account identifier is eligible for a reward further comprises:
performing an account number lookup to determine if said payment account identifier is eligible for a reward.

9. The method of claim 1, wherein said authorization request message further includes data identifying at least one of a merchant and an acquirer associated with said point of interaction.

10. The method of claim 9, further comprising determining that said requested purchase transaction is eligible for a reward, the method comprising:
determining that purchases at least one of said merchant and said acquirer are eligible for a reward.

11. The method of claim 1, further comprising determining that said requested purchase transaction is eligible for a reward, the method comprising:
determining if said purchase amount is within a threshold qualifying for a reward.

12. The method of claim 1, wherein said reward message is at least one of (i) a plain text message for display at said point of interaction, (ii) a plain text message for printing at said point of interaction, and (iii) a lookup code for transmission to said point of interaction.

13. The method of claim 1, further comprising:
determining, by a merchant system, if said requested purchase transaction qualifies for a merchant-specific reward.

14. An apparatus comprising:
a processor; and
a memory in communication with the processor, the memory storing program instructions, the processor operative with the program instructions to:
receiving, from a point of interaction, an authorization request message identifying a requested purchase transaction, said authorization request message including data identifying a payment account identifier and a purchase amount;
determining that said payment account identifier is eligible for a reward and selecting a reward message associated with said reward; and
transmitting an authorization response message including said reward message to said point of interaction for communication to an account holder.

15. A rewards system, comprising:
a point of interaction generating a transaction authorization request message including a purchase amount, and a customer account identifier; and
an authorization system, receiving the transaction authorization request message and determining that the customer account identifier is eligible for rewards processing, the authorization system generating an updated transaction authorization request message, the updated transaction authorization request message including information identifying at least a first reward message.

16. The rewards system of claim 15, wherein the updated transaction authorization message further includes a discount amount and an updated purchase amount based on said discount amount.

17. The rewards system of claim 15, further comprising:
at least a first issuer system, receiving said updated transaction authorization message, and performing authorization processing on the updated transaction authorization message to generate a transaction authorization response message for transmission to said point of interaction to complete the purchase transaction.

18. The rewards system of claim 16, further comprising:
at least a first issuer system, receiving said updated transaction authorization message, and performing authorization processing on the updated transaction authorization message by analyzing said updated purchase amount and said customer account identifier to generate a transaction authorization response message for transmission to said point of interaction to complete the purchase transaction.

19. The rewards system of claim 15, wherein said at least first reward message is at least one of (i) a plain text message for display at said point of interaction, (ii) a plain text message for printing at said point of interaction, and (iii) a lookup code for transmission to said point of interaction.

20. The rewards system of claim 16, wherein said at least first reward message includes information communicating the amount of said discount.
